(19) United States
(12) Patent Application Publication
(10) Pub. No.: US 2006/0188670 A1
(43) Pub. Date: Aug. 24, 2006

(54) Recording medium producing method and recording medium

(75) Inventors: Shigeru Kojima, Tokyo (JP); Rieko Ren, Tokyo (JP); Yukako Taka, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/351,383

(22) Filed: Feb. 10, 2006

(30) Foreign Application Priority Data
Feb. 18, 2005 (JP) JP2005-041904

(51) Int. Cl. B05D 3/02; B41M 5/40

(52) U.S. Cl. 428/32.34; 427/376.1

(57) ABSTRACT

A recording medium producing method comprising a step of coating a coating liquid which is a mixture of an inorganic fine particle dispersion and a water-soluble binder on a support, wherein the inorganic fine particle dispersion is prepared by a process comprising the steps of heating the inorganic fine particle dispersion at a temperature of from 45° C. to 60° C. for a time of from 0.5 to 5 hours, standing the inorganic fine particle dispersion at a temperature of from 10° C. to 40° C. for a time of from 0.5 to 5 hours, and mixing the inorganic fine particle dispersion is mixed with the water-soluble binder. This invention provides a method for producing a recording medium for ink-jet recording by supplying a coating liquid which is stable in the viscosity Without increasing during standing period and a recording medium produced by the producing method which has no coating defect and gives high image density.

This application is based on Japanese Patent Application No. 2005-041904 filed on Feb. 18, 2005, in Japanese Patent Office, the entire content of which is hereby incorporated by reference.

### FIELD OF THE INVENTION

The invention relates to a recording medium producing method and a recording medium principally employed for ink-jet recording method.

### BACKGROUND OF THE INVENTION

Hitherto, recording medium for ink-jet recording, which has high quality and high productivity, has been demanded in many fields. For satisfying such the demands, a recording medium has been known which is produced by coating and drying a coating liquid prepared by mixing a silica dispersion and a water-soluble binder onto a support.

However, a method has been required for solving problems that gelling or considerable viscosity increasing are caused on the occasion of mixing the silica dispersion and the water-soluble binder and that the viscosity of the mixture is increased during the standing thereof. Hitherto, methods have been disclosed in which the inorganic fine particle dispersion is stood for a long time at room temperature or subjected to a heating treatment such as those described in Patent Document 1 to 3.

Patent Document 1 describes to stand a silica dispersion at least one of conditions of a time of not less than 5 hours and a temperature of not less than 50° C. However, time after the heating is not disclosed. Patent Document 2 describes a method for producing a recording medium in which a silica dispersion is stood at a temperature of not more than 50° C. and a time of less than 5 hours. Patent Document 3 describes a method in which silica is dispersed by two steps and stood under at least one of conditions of a time of not less than 5 hours and a temperature of more than room temperature. Patent Document 4 describes an invention in which a silica dispersion is stood for a time of not less than (37−T)×12+24 in which T is a heating temperature of from 25 to 37° C.

Hitherto, a method is usually applied in which the dispersion is stood for a long period such as that described in Patent Document 4, and there is no disclosure noting to any treatment after such the treatment. Moreover, the usual method only by heating is insufficient for stably supplying the coating liquid for high speed coating to obtain a high quality recording medium.

Patent Document 1: Tokkai 2001-149856

Patent Document 2: Tokkai 2003-276303

Patent Document 3: Tokkai 2004-43628

Patent Document 4: Tokkai 2004-255596

### SUMMARY OF THE INVENTION

The invention is attained for solving the above problems.

An object of the invention is to provide a method for producing a recording medium for ink-jet recording by supplying a coating liquid which is stable in the viscosity during standing period and a recording medium produced by the producing method which has few coating defect and gives high image density.

It is found by the inventors that the stability of the viscosity and that of coating are largely varied depending on the standing time between the completion of the heating treatment of the inorganic fine particle dispersion and the mixing with the water-soluble binder.

It is cleared that the heat treatment time and the standing time after the heat treatment are important for supplying the coating liquid stable in the physicochemical properties to produce the recording medium having stable quality. In the course of investigation after that, it is understood that the coating liquid having stable physicochemical properties can be supplied by mixing the inorganic fine particle dispersion with the water-soluble binder within 5 hours after the heat treatment. Moreover, it is cleared that gelatinization of the liquid tends to be caused by strongly increasing in the viscosity on the occasion of mixing with the water-soluble binder when the standing time is too short. Thus the present invention is attained.

The object of the invention can be attained by the following constitution.

(1) A recording medium producing method comprising a step of coating a coating liquid which is a mixture of an inorganic fine particle dispersion and a water-soluble binder on a support, wherein the inorganic fine particle dispersion is prepared by a process comprising the steps of heating a inorganic fine particle dispersion at a temperature of from 45° C. to 60° C. for a time of from 0.5 to 5 hours, standing the inorganic fine particle dispersion at a temperature of from 10° C. to 40° C. for a time of from 0.5 to 5 hours, and mixing the inorganic fine particle dispersion with the water-soluble binder.

(2) The recording medium producing method of (1), wherein the inorganic fine particle is fumed silica and the inorganic fine particle dispersion contains a cationic polymer.

(3) The recording medium producing method of (1) or (2), wherein the inorganic fine particle dispersion contains a water-soluble poly-valent metal compound.

(4) The recording medium producing method of (2), wherein the inorganic fine particle dispersion contains two or more kinds of cationic polymer.

(5) A recording medium produced by the producing method of (1).

A method for producing a recording medium for ink-jet recording by supplying a coating liquid which is stable in the viscosity during standing period and a recording medium produced by the producing method which has few coating defect and gives high image density can be provided by the invention.

### DESCRIPTION OF THE PREFERRD EMBODIMENTS

In the invention, the inorganic fine particle dispersion is heated at a temperature of from 45° C. to 60° C. for a time of from 0.5 to 5 hours, and then stood at a temperature of from 10° C. to 40° C. for a time of from 0.5 to 5 hours, and mixed with the water-soluble binder.

When the inorganic fine particle dispersion is mixed with the water-soluble binder just after the completion of dispersion without heating treatment, gelatinization of the liquid, strong viscosity rising and viscosity rising during standing of the mixed liquid are caused sometimes.

When the heating temperature is too high, the viscosity of the inorganic fine particle dispersion is strongly raised or gelled substance is formed sometimes even if the heating time is shortened. Furthermore, a problem of gelled substance formation on the occasion of mixing with the water-soluble binder is also caused.

The effect of the invention cannot be obtained when the heating is carried out at a temperature of less than 40° C. It is supposed that the reaction of the inorganic fine particles is strongly accelerated by heating at a temperature of not less than 45° C. The gelatinization of the coating liquid and the viscosity increasing during the standing period can be inhibited by heating for long period even though the heating is carried out at about 40° C., but problems such as that the gelatinization of the dispersion and lowering in the printing image density are sometimes caused.

In some cases, gelled substances are formed and adhere onto the wall of the heating vessel when the dispersion is heated for long time. For avoiding such the problem, the heating time should be not more than 5 hours. However, the behavior of the liquid similar to that of the liquid without heating treatment occurs so that the viscosity of the liquid rises when the heating time is too short. Though the viscosity can be lowered by diluting the liquid with water when the viscosity is excessively high, the drying load is increased so as to lower the production efficiency.

As above-mentioned, the heating at a temperature of from 45° C. to 60° C. for a time of from 0.5 to 5 hours is important from the viewpoint of stability of the coating liquid, and the treatment at a temperature of from 48 to 55° C. for 1 to 3 hours is more preferable, and that at a temperature of from 48 to 53° C. for 1.5 to 2.5 hours is further preferably.

Moreover, the standing at a temperature of from 10° C. to 40° C. for a time of from 0.5 to 5 hours after the heating is particularly important. When the standing time after heating is excessively long, unevenness and cracks on the coated layer tend to be caused. It is supposed that the interaction between the inorganic particles is varied so that the good coated layer cannot be obtained when the standing time after the heating exceeds 5 hours. The standing time of from 1 to 3 hours is particularly preferable.

When the standing time is too short, the strong increase in the viscosity and the gelatinization are caused on the occasion of mixing with the water-soluble binder.

The dispersion preferably contains a water-soluble poly-valent metal compound or a cationic polymer. The stability of the coating liquid is particularly improved by the presence of them.

The time from the completion of the dispersion to the heating is preferably from 0.5 to 24 hours, and more preferably from 1 to 18 hours. The liquid is preferably stirred during the standing and the heating treatment. The standing after the heating treatment is preferably performed at a temperature of from 10° C. to 40° C. Excessively high temperature causes lowering in the viscosity of the coating liquid, the formation of gelled substance in the dispersion and the coating defect, and excessively low temperature causes insufficient mixing on the occasion of mixing with the water-soluble binder and the formation of gelled substance in the coating liquid.

In the invention, the inorganic fine particle dispersion is the dispersion containing substantially no water-soluble binder, and the liquid substantially containing the water-soluble binder is referred to as the coating liquid.

For dispersing the inorganic particles, various kinds of known dispersing apparatus can be applied, for example, a high speed rotation disperser, a medium stirring type disperser such as a ball mill and a sand mill, a ultrasonic disperser, a colloid mill disperser, a roll mill disperser and a high pressure disperser.

[Inorganic Particle]

Silica fine particle is preferable for the inorganic fine particle to be employed in the invention though the particle is not specifically limited.

The silica fine particle relating to the invention is preferably wet processed silica prepared by a precipitation method or gelling method using sodium silicate as the raw material and fumed silica.

As examples of the wet processed silica, Finesil manufactured by Tokuyama Co., Ltd. by the precipitation method and NIPGEL manufactured by Nihon Silica Kogyo Co., Ltd. by the gelling method are available on the market. The precipitated silica and the gelling method silica are each constituted by secondary coagulated particles formed by primary particle having a diameter of about 10 to 60 nm and that having a diameter of about 3 to 10 nm, respectively.

The primary particle diameter of the wet processed silica is preferably not less than 3 nm from the viewpoint of production stability and not more than 50 nm from the viewpoint of transparency of the layer, though there is no lower limit of the diameter of primary particle of the wet processed silica. The wet processed silica produced by the gelling method is preferable since which is generally smaller in the primary particle diameter than that of the precipitated silica.

The fumed silica is one produced by a burning method using silicon tetrachloride and hydrogen as raw materials. For example, Aerosil series, manufactured by Nihon Aerosil Co., Ltd., is available on the market.

The fumed silica is particularly preferred in the invention because-high porosity can be obtained and coarse particles are difficultly formed on the occasion of preparing a cationic composite fine particle dispersion. Moreover, the fumed silica has a merit that the particles can be dispersed by lower energy compared with the wet processed silica since the secondary coagulates of the fume silica are formed by relatively lower interaction than that in the wet processed silica.

The fumed silica having an average primary particle diameter of from 3 to 50 nm is preferable. When the average primary particle diameter is not more than 50 nm, the high glossiness of the recording medium can be attained and the lowering in the maximum density caused by irregular reflection at the paper surface can be inhibited so that an image with high clearness and high density can be obtained.

In the invention, the average diameter of the fine silica particle can be determined by simple average (number average) of the diameters of optionally selected several hundreds silica particles measured by electron microscopic observation of the particles or surface or cross section of the ink absorbing layer constituted by the silica particles. The diameter of the individual particle is that of an assumed circle having the area equal to the projection area of the particle.

In a particularly preferable embodiment, a porous ink absorbing layer is formed by secondary or higher coagulated particles. In such the case, the average diameter of the coagulated particle is preferably from 20 to 200 nm for obtaining a recording medium having high ink absorbing ability and high glossiness.

It is also preferable that the moisture content of the fumed silica is conditioned by storing the silica in an atmosphere having a humidity of from 20 to 60% for 3 or more days.

The adding amount of the silica fine particle is usually from 5 to 30 g, and preferably from 10 to 25 g per square meter of the recording medium, though the amount is largely depending on the required ink absorbing capacity, the porosity of the porous layer and the kind of the water-soluble binder. The ratio of the silica fine particles to the water-soluble binder in the ink absorbing layer is approximately from 2:1 to 20:1, and particularly preferably from 3:1 to 10:1 in weight.

The ink absorbing capacity rises accompanied with increase in the adding amount of the silica fine particles. However, probability of occurrence of defects such as curling and cracking is increased in such the case. Therefore, the ink absorbing capacity is preferably increased by rising the porosity. Preferable porosity is from 40 to 75%.

[Cationic Polymer]

The cationic polymer is a polymer having a primary to tertiary amine group, a quaternary ammonium group or a quaternary phosphonium group on the main chain or a side chain thereof, and compounds known in the field of ink-jet recording medium can be employed. Substantially water soluble ones are preferable form the easiness of production.

Examples of the cationic polymer include polyethyleneimine, polyallylamine, polyvinylamine, a dicyandiamidopolyalkylene polyamine condensate, a polyalkylene polyamine dicyandiamide ammonium salt condensate, a dicaynadiamide formalin condensate, a polymer of epichlorohydrine-dialkylamine addenda, a diallyldimethylammonium chloride polymer, a diallyldimethylammonium chloride.SO₂ copolymer, polyvinylimidazole, poly(vinyl pyrrolidone), a vinylimidazole copolymer, polyvinylpyridine, polyamidine, chitosan, cationized starch, a vinylbenzyltrimethylammonium chloride polymer, a (2-methacryloyloxyethyl)trimethylammonium chloride polymer and a dimethylaminoethyl methacrylate polymer.

Moreover, the cationic polymers described in “Kagaku Kogyo Jihou” 15 and 25, Aug. 1998, and the polymer dye mordants described in “Koubunshi Yakuzai Nyuumon”, p. 787, 1992, Sanyou Kasei Kogyo Co., Ltd. are exemplified.

The average molecular weight of the cationic polymer is preferably within the range of from 2,000 to 500,000, and more preferably from 10,000 to 100,000.

The average molecular weight in the invention is a number average molecular weight which is defined by a polyethylene glycol conversed value measured by a gel permeation chromatography.

When the cationic polymer is previously added into the coating liquid, the polymer may be added uniformly or in a form of composite particle with the inorganic particle. For forming the composite particle, a method in which the cationic polymer is mixed with the inorganic particles so as to be covered by absorption, a method in which the above covered particles are further coagulate to form higher dimensional composite particles and a method in which coarse coagulates formed by mixing the above coagulated particles are dispersed by a dispersing apparatus to form uniform composite particles can be applied.

The cationic polymer usually has a water-soluble group and is water soluble, but sometimes water insoluble according to the composition of the polymer. The insoluble polymer can be used by dissolving in a water miscible organic solvent though the polymer is preferably water-soluble for easiness of the production.

The water-miscible organic solvent is an organic solvent capable of being dissolved in water in a ratio of not less than approximately 10%, for example, an alcohol such as methanol, ethanol, isopropanol and n-propanol, a glycol such as ethylene glycol, diethylene glycol and glycerol, an ester such as ethyl acetate and propyl acetate, a ketone such as acetone and methyl ethyl ketone, and an amide such as N,N-dimethylformamide. In such the case, the using amount of the organic solvent is preferably smaller than that of water.

The cationic polymer is usually used within the range of from 0.1 to 10 g, and preferably from 0.2 to 5 g, per square meter of the recording medium. When plural kinds of the cationic polymer are employed, the total amount of them is preferably within the above range.

Various kinds of additives other than the above-described may be added into the ink absorbing layer and another layer to be provided according to necessity, and an image preservability improving agent such as a UV absorbent, an antioxidant and an anti-spreading agent is preferably added.

[Water-Soluble Polyvalent Metal Compound]

As above-described, the recording medium (recording paper) preferably contains a water-soluble polyvalent metal compound.

Examples of the water-soluble polyvalent metal compound relating to the invention include chloride, sulfate, nitrate, acetate, formate, succinate, molonate or chloroacetate of aluminum, calcium, magnesium, zinc, iron, strontium, barium, nickel, copper, scandium, gallium, indium, titanium, zirconium, tin or lead. Among them, water-soluble salts of aluminum, calcium, magnesium, zinc and zirconium are preferable because these metal ions are colorless. The water-soluble aluminum compound and the water-soluble zirconium compound are particularly preferable since these compounds are superior in the image spreading inhibition ability during storage for long period.

Concrete examples of the water-soluble aluminum compound include poly(aluminum chloride) (basic aluminum chloride), aluminum sulfate, basic aluminum sulfate, aluminum potassium sulfate (alum), ammonium aluminum sulfate (ammonium alum), sodium aluminum sulfate, aluminum nitrate, aluminum phosphate, aluminum carbonate, poly(aluminum sulfate silicate), aluminum acetate and basic aluminum butylate. “Water-soluble” of the polyvalent metal compound means that the compound can be dissolved in a concentration of not less than 1%, and preferably not less than 3%, by weight in water of 20° C.

The most preferable water-soluble aluminum compound from the viewpoint of ink absorbability is basic aluminum chloride having a basic degree of not less than 80%, which is represented by the following molecular formula.
[Al₂(OH)ₙCl₆₋ₙ]ₘ

In the above, 0<n<6, m≦10

The basic degree is expressed by n/6×100 (%).

Preferable examples of water-soluble zirconium compound include zirconium carbonate, zirconium ammonium carbonate, zirconium acetate, zirconium nitrate, acidic zirconium chloride, zirconium butylate and zirconium citrate. Zirconium ammonium carbonate and zirconium acetate are particularly preferred. Acidic zirconium chloride and zirconium acetate are particularly preferable for image spreading inhibition ability during storage for long period.

[Hardening Agent]

In the invention, the silica fine particle dispersion for the outermost layer may be contains a hardening agent for the binder for preventing cracks on the occasion of the production (coating and drying). As the hardening agent, a boron compound is preferable and boric acid and salts thereof are more preferable. The boric acid and salt thereof are an oxygen acid having a boron atom as the center atom and the salt thereof concretely including orthoboric acid, diboric acid, metaboric acid, tetraboric acid, pentaboric acid, octaboric acid and salts thereof. The using amount of the boric acid or salt thereof is usually from 5 to 500 mg, preferably from 10 to 300 mg, per gram of the water-soluble binder. When no hardening agent is used, a binder capable of crosslinking itself by ionizing radiation such as UV rays and electron rays is preferably employed.

[Support of Recording Medium (Substrate)]

Supports known in the field of the ink-jet recording medium can be optionally employed in the invention.

Sheets and plates of usual paper, cloth or wood are applicable for the water absorbable support, and the paper is most preferable because that is superior in the moisture absorbing ability of the material itself and in the cost. As the paper support, those principally made from wood pulp, for example, chemical pulp-such as LBKP and NBKP, mechanical pulp such as GP, CGP, RMP, TMP, CTMP, CMP and PGW and a recycle paper pulp such as DIP can be employed. Various fiber shaped substance such as synthesized pulp, synthesized fiber and inorganic fiber can be optionally employed as the raw material according to necessity.

Known various additives such as a sizing agent, a pigment, a paper strengthening agent, a fixing agent, a fluorescent whitening agent, a wet strengthening agent and a cationizing agent can be added into the paper support according to necessity.

The paper support can be produced by various kinds of paper making machine such as a foundrinier paper machine, a cylinder paper machine and a twin wire paper machine from a mixture of the fiber shaped substance such as the wood pulp and the various additives. Moreover, the paper may be subjected to size press treatment using starch or poly(vinyl alcohol), and various types of coating treatment or calender treatment in the course of paper making or by the paper making machine according to necessity.

A non-moisture absorbable support such as a plastic resin film support and a paper support laminated with plastic resin film on the surface thereof can be preferably applied in the invention.

A plastic resin film support such as polyester film, poly(vinyl chloride) film, polypropylene film, cellulose triacetate film, polystyrene film and a laminated film thereof are usable. These plastic films may be transparent or semitransparent.

Particularly preferable support in the invention is a paper support laminated with plastic resin on both sides thereof and the most preferable support is a paper support laminated with polyolefin resin on both sides thereof.

The non-moisture absorbable paper support laminated with polyethylene is described below; the polyethylene is the type of the most preferable polyolefin.

The raw paper to be used in the paper support is mainly made from the wood pulp and, according to necessity, synthesized pulp such as polypropylene or synthesized fiber such as nylon and polyester is added. As the wood pulp, LBKP, LBSP, NBKP, NBSP, LDP, LUKP and NUKP are employable, and one having high content of short fiber such as LBPK, NBSP, LBSP, NDP and LDP is preferably employed as major component. However, the content of LBSP or LDP is preferably from 10 to 70% by weight.

The polyethylene layer on which the ink absorbing layer is coated is preferably improved in the opacity and the whiteness by addition of rutile type or anatase type titanium oxide such as widely applied in photographic paper. The content of the titanium oxide is from 1 to 20%, and preferably from 2 to 15%, by weight of the polyethylene.

A pigment and a fluorescent whitening agent each having high heat resistivity may be added to the polyolefin layer for controlling the color of the white background. Examples of the color pigment include ultramarine, Prussian blue, cobalt blue, phthalocyanine blue, manganese blue, cerulean, tungsten blue, molybdenum blue and anthraquinone blue. Examples of the fluorescent whitening agent include dialkylaminocoumaline, bisdimethylaminostylbene, bismethylaminostylbene, 4-alkoxy-1,8-naphthalenedicarboxylic acid-N-alkylimide, bisbenzoxazolylethylene and dialkylstylbene.

The using amounts of the polyethylene on the front side and backside of the paper are decided so as to optimize the curling at low and high temperature after provision of the ink absorbing layer and the backing layer. The thickness of the polyethylene layer is usually from 15 to 50 μm on the ink absorbing layer side and from 10 to 40 μm on the backing side. The ratio of the amounts of the polyethylene on the front side to the backside is preferably decided for controlled the curling which is varied depending on the kind and thickness of the ink absorbing layer and the thickness of the paper. The thickness ratio of the polyethylene on the front side to that on the backside is approximately from 3/1 to 1/3.

[Coating Method]

The ink-jet recording medium can be produced by separately or simultaneously coating and drying the constituting layers by a method suitably selected from known coating methods.

For coating, for example, a roller coating method, a rod bar coating method, an air-knife coating method, a spray coating method, a curtain coating method, a slide bead coating method described in U.S. Pat. Nos. 2,761,419 and 2,761,791, and an extrusion coating method are preferably applied.

The slide bead coating method and the curtain coating method are preferable since the coating liquids containing the inorganic fine particle dispersion can be simultaneously coated into multi-layered state in high speed.

When two or more constituting layers are simultaneously coated, the viscosities of each of the layers are preferably from 5 to 100 mPa·s, and more preferably from 10 to 50 mPa·s in the case of the slide bead coating system. In the case of the curtain coating system, the viscosity is preferably from 5 to 1,200 mPa·s, and more preferably from 25 to 500 mPa·s.

The viscosity of the coating liquid at 15° C. is preferably not less than 100 mPa·s, more preferably from 100 to 30,000 mPa·s, further preferably from 3,000 to 30,000 mPa·s, and most preferably from 10,000 to 30,000 mPa·s.

### EXAMPLES

The typical embodiments of the invention are described bellow as examples for explaining the invention. The invention is not limited to the examples.

### Example 1

(Preparation of Inorganic Fine Particle Dispersion D1)

| | | |
|---|---|---|
| Inorganic fine particle (Fumed silica, Aerogil 200, | 50 | kg |
| Nihon Aerogil Co., Ltd.) | | |
| Water | 74 | L |
| Boric acid | 0.27 | kg |
| Borax | 0.24 | kg |
| Ethanol | 2.2 | L |
| Cationic polymer P-1, 25% aqueous solution | 17 | L |
| Anti-color fading agent AF1*¹, | 8.5 | L |
| 10% aqueous solution | | |
| Fluorescent whitening agent*² | 0.1 | L |

The above components were dispersed by a high pressure homogenizer manufactured by Sanwa Co., Ltd., to prepare Silica Dispersion D1.

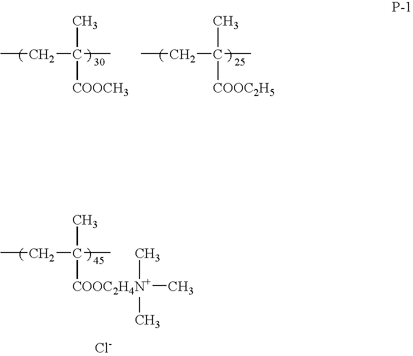

The silica dispersion was subjected to heating treatment described in Table 1, and then a coating liquid was prepared as follows. The dispersion was stood for 15 hours at room temperature (25° C.) before the heating.

In the preparation of Recording medium 1, the dispersion is not heated and stood for 21 hours at room temperature (25° C.), and then the following coating liquid was prepared.

The dispersion was stirred in the course of preparation of the entire recording mediums.

The standing temperature after the heating treatment was room temperature (25° C.).

(Preparation of Porous Layer Coating Liquid)

The following additives were successively mixed into the above prepared silica dispersion to prepare each of porous layer coating liquids. The adding amount is represented by the amount per liter of the coating liquid.

<First Layer Coating Liquid: Lowermost Layer)

| | | |
|---|---|---|
| Silica Dispersion D1 | 610 | ml |
| Poly(vinyl alcohol) (6.5% aqueous solution of a mixture | 320 | ml |
| of PVA235 and PVA245, Kraray Co., Ltd., in a ratio of | | |
| 7:3) | | |
| Latex dispersion (Polysol AE803, Showa Koubunshi Co., | 20 | ml |
| Ltd.) | | |
| Ethanol | 8.5 | ml |
| Water to make | 1,000 | ml |

<Second Layer Coating Liquid>

| | | |
|---|---|---|
| Silica Dispersion D1 | 630 | ml |
| Poly(vinyl alcohol) (6.5% aqueous solution of a mixture | 280 | ml |
| of PVA235 and PVA245, Kraray Co., Ltd., in a ratio of | | |
| 7:3) | | |
| Latex dispersion (Polysol AE803, Showa Koubunshi Co., | 5 | ml |
| Ltd.) | | |
| Ethanol | 8 | ml |
| Water to make | 1,000 | ml |

<Third Layer Coating Liquid>

| | | |
|---|---|---|
| Silica Dispersion D1 | 660 | ml |
| Poly(vinyl alcohol) (6.5% aqueous solution of a mixture | 280 | ml |
| of PVA235 and PVA245, Kraray Co., Ltd., in a ratio of | | |
| 7:3) | | |
| Ethanol | 3 | ml |
| Water to make | 1,000 | ml |

<Fourth Layer Coating Liquid: Uppermost Layer)

| | | |
|---|---|---|
| Silica Dispersion D1 | 690 | ml |
| Poly(vinyl alcohol) (6.5% aqueous solution of a mixture | 260 | ml |
| of PVA235 and PVA245, Kraray Co., Ltd., in a ratio of | | |
| 7:3) | | |
| Surfactant (6% aqueous solution of Coatamine 24P, Kao | 3.0 | ml |
| Co., Ltd.) | | |
| Ethanol | 3.0 | ml |
| Water to make | 1,000 | ml |

(Coating)

The above coating liquids were simultaneously coated by a slide bead coating system to prepare Recording medium 1.

The coating liquids were coated within the range of time of from 2 to 6 hours after the preparation thereof.

Recording mediums 2 through 28 were prepared in the same manner as in Recording medium 1 except that the preparation conditions were changed as described in Table 1.

<Evaluation of Characteristics>

<<State of Dispersion>>

The situation of the dispersion on the occasion of the heating and that of the wall of the vessel were visually observed and evaluated according to the following norms.

A: No problem was posed in the course of the heating and on the vessel wall.

B: No problem was posed in the course of the heating, but some gelled substances adhered on the vessel wall.

C: Occurrence of gelled substances was visually observed in the course of the heating.

<<State of Mixing>>

The state of mixing of each of the coating liquids was visually observed and the viscosity of the coating liquid was measured after 10 minutes of mixing. The evaluation result of the worst coating liquid among the four layer coating liquids is listed in the table.

A: The liquid was finely mixed and the viscosity was within suitable range.

B: The liquid was finely mixed but the viscosity was higher a little.

C: The liquid was finely mixed but the viscosity was near the highest limit of the acceptable range for coating.

D: The liquid was finely mixed but the viscosity was over the highest limit of the acceptable range for coating.

E: Occurrence of gelled substances was observed on the occasion of the nixing and the viscosity was over the highest limit of the acceptable range for coating.

When the liquid was finely mixed, the coating can be performed by diluting the liquid, but problems of lowering in the production efficiency and the viscosity increasing during the standing period were posed.

<<Viscosity Increasing During Standing>>

The viscosity of the coating liquid was re-measured at 3 hours after the completion of mixing for determining the variation in the viscosity from just after the mixing.

A: Increasing in the viscosity was not more than 0.3 mPa·sec per hour.

B: Increasing in the viscosity was not more than 0.6 mPa·sec per hour.

C: Increasing in the viscosity was not more than 1.0 mPa·sec per hour.

D: Increasing in the viscosity was not more than 2.0 mPa·sec per hour.

E: Increasing in the viscosity exceeded 2.0 mPa·sec per hour.

In the production process, the coating tends to become difficult when the increasing in the viscosity exceeds 1.0 mPa·sec per hour.

<<Coating Defect>>

The coated layer surface of 100 cm×100 cm was observed and the occurrence of line defect and the stability of the surface were evaluated as follows.

A: No defect was observed.

B: Line-shaped coating defects or variation of the surface was slightly observed.

C: Line-shaped coating defects was clearly observed.

<<Printed Image Density>>

A black solid image was printed under ordinary environment by an ink-jet printer PM-950C, manufactured by Epson Co., Ltd., and the reflective density of the printed image was measured. The reflective density was measured by a spectral color densitometer X-Rite 938, manufactured by X-Rite Co., Ltd.

The above evaluation results about Recording mediums 1 through 30 are listed in Table 1.

TABLE 1

| | | | Time | | | | | Printed | |
|---|---|---|---|---|---|---|---|---|---|
| | Heating | Heating | after | | | | | image | |
| | temperature | time | heating | *1 | *2 | *3 | *4 | density | Remarks |
| Recording | (Mixed after 21 hours of | | | — | D | C | B | 1.94 | Comp. |
| medium 1 | dispersion without | | | | | | | | |
| | heating) | | | | | | | | |
| Recording | 40° C. | 2 hours | 2 hours | A | C | D | B | 1.95 | Comp. |
| medium 2 | | | | | | | | | |
| Recording | 48° C. | 2 hours | 2 hours | A | B | B | A | 2.18 | Inv. |
| medium 3 | | | | | | | | | |
| Recording | 55° C. | 2 hours | 2 hours | A | B | C | A | 2.09 | Inv. |
| medium 4 | | | | | | | | | |
| Recording | 60° C. | 2 hours | 2 hours | A | C | C | A | 2.05 | Inv. |
| medium 5 | | | | | | | | | |
| Recording | 70° C. | 2 hours | 2 hours | C | D | E | C | 2.00 | Comp. |
| medium 6 | | | | | | | | | |
| Recording | 48° C. | 20 | 2 hours | A | D | C | C | 1.85 | Comp. |
| medium 7 | | minutes | | | | | | | |
| Recording | 48° C. | 40 | 2 hours | A | C | C | A | 2.05 | Inv. |
| medium 8 | | minutes | | | | | | | |
| Recording | 48° C. | 1 hour | 2 hours | A | B | C | A | 2.10 | Inv. |
| medium 9 | | | | | | | | | |
| Recording | 48° C. | 3 hours | 2 hours | A | B | C | A | 2.13 | Inv. |
| medium 10 | | | | | | | | | |
| Recording | 48° C. | 5 hours | 2 hours | A | C | C | A | 2.06 | Inv. |
| medium 11 | | | | | | | | | |
| Recording | 48° C. | 6 hours | 2 hours | C | C | D | B | 1.95 | Comp. |
| medium 12 | | | | | | | | | |
| Recording | 48° C. | 2 hours | 20 | A | D | E | C | 1.80 | Comp. |
| medium 13 | | | minutes | | | | | | |
| Recording | 48° C. | 2 hours | 40 | A | C | C | A | 2.12 | Inv. |
| medium 14 | | | minutes | | | | | | |
| Recording | 48° C. | 2 hours | 1 hour | A | B | C | A | 2.14 | Inv. |
| medium 15 | | | | | | | | | |
| Recording | 48° C. | 2 hours | 3 hours | A | B | C | A | 2.16 | Inv. |
| medium 16 | | | | | | | | | |
| Recording | 48° C. | 2 hours | 5 hours | A | C | C | A | 2.14 | Inv. |
| medium 17 | | | | | | | | | |
| Recording | 48° C. | 2 hours | 6 hours | A | D | D | C | 1.85 | Comp. |
| medium 18 | | | | | | | | | |
| Recording | 45° C. | 5 hours | 6 hours | A | C | C | C | 1.87 | Comp. |
| medium 19 | | | | | | | | | |
| Recording | 45° C. | 6 hours | 5 hours | C | C | B | B | 1.94 | Comp. |
| medium 20 | | | | | | | | | |
| Recording | 48° C. | 40 | 40 | A | C | C | A | 2.11 | Inv. |
| medium 21 | | minutes | minutes | | | | | | |
| Recording | 48° C. | 40 | 5 hours | A | B | C | A | 2.03 | Inv. |
| medium 22 | | minutes | | | | | | | |
| Recording | 48° C. | 5 hours | 40 | A | B | C | A | 2.02 | Inv. |
| medium 23 | | | minutes | | | | | | |
| Recording | 48° C. | 5 hours | 5 hours | A | C | C | A | 2.04 | Inv. |
| medium 24 | | | | | | | | | |
| Recording | 40° C. | 5 hours | 1 hour | A | D | C | B | 1.95 | Comp. |
| medium 25 | | | | | | | | | |
| Recording | 40° C. | 5 hours | 5 hours | A | D | C | B | 1.87 | Comp. |
| medium 26 | | | | | | | | | |
| Recording | 70° C. | 40 | 1 hour | C | D | D | C | 1.87 | Comp. |
| medium 27 | | minutes | | | | | | | |
| Recording | 70° C. | 40 | 5 hours | C | D | D | C | 1.89 | Comp. |
| medium 28 | | minutes | | | | | | | |

*1: State of dispersion,
*2: State of mixing,
*3: Viscosity increasing during standing,
*4: Coating defect
Comp.: Comparative,
Inv.: Inventive.

It is understood that the samples according to the invention are good in all the characteristics.

### Example 2

Recording mediums were prepared in the same manner as in Example 1 except that the composition of the inorganic fine particle dispersion was changed as follows and the preparation temperature and time were changed as described in Table 2.

(Preparation of Inorganic Fine Particle Dispersion D2)

| | | |
|---|---|---|
| Inorganic fine particle (Fumed silica, Aerogil 200, | 50 | kg |
| Nihon Aerogil Co., Ltd.) | | |
| Water | 74 | L |
| Boric acid | 0.27 | kg |
| Borax | 0.24 | kg |
| Ethanol | 2.2 | L |
| Basic aluminum chloride (Takibine #1500, 27.3%, Taki | 4 | L |
| Kagaku Co., Ltd.) | | |
| Anti-color fading agent AF1*¹, 10% aqueous solution | 8.5 | L |
| Fluorescent whitening agent*² | 0.1 | L |

*¹Anti-color fading agent AF-1 HO—N(C₂H₄SO₃Na)₂
*²Uvitex NFW Liquid, Ciba Specialty Chemicals Co., Ltd.

The above components were dispersed by a high pressure homogenizer manufactured by Sanwa Co., Ltd., to prepare Silica Dispersion D2.

Thus obtained Recording mediums 31 through 37 was evaluated in the same manner as in Example 1.

Results of the evaluation are listed in Table 2.

TABLE 2

| | | | Time | | | | | Printed | |
|---|---|---|---|---|---|---|---|---|---|
| | Heating | Heating | after | | | | | image | |
| | temperature | time | heating | *1 | *2 | *3 | *4 | density | Remarks |
| Recording | 48° C. | 2 hours | 20 | A | E | E | C | 1.72 | Comp. |
| medium 31 | | | minutes | | | | | | |
| Recording | 48° C. | 2 hours | 40 | A | C | B | A | 2.15 | Inv. |
| medium 32 | | | minutes | | | | | | |
| Recording | 48° C. | 2 hours | 1 hour | A | B | B | A | 2.19 | Inv. |
| medium 33 | | | | | | | | | |
| Recording | 48° C. | 2 hours | 2 hours | A | B | A | A | 2.20 | Inv. |
| medium 34 | | | | | | | | | |
| Recording | 48° C. | 2 hours | 3 hours | A | B | B | A | 2.19 | Inv. |
| medium 35 | | | | | | | | | |
| Recording | 48° C. | 2 hours | 5 hours | A | C | B | A | 2.17 | Inv. |
| medium 36 | | | | | | | | | |
| Recording | 48° C. | 2 hours | 6 hours | A | E | E | C | 1.78 | Comp. |
| medium 37 | | | | | | | | | |

*1: State of dispersion,
*2: State of mixing,
*3: Viscosity increasing during standing,
*4: Coating defect
Comp.: Comparative,
Inv.: Inventive.

It is understood that the effect of the time after the mixing is large when the polyvalent metal is contained.

### Example 3

Recording mediums were prepared in the same manner as in Example 1 except that composition of the inorganic fine particle dispersion was changed as follows and the dispersion was stood at the temperature and the time described in Table 3.

(Preparation of Inorganic Fine Particle Dispersion D3)

| | | |
|---|---|---|
| Inorganic fine particle (Fumed silica, Aerogil 200, | 50 | kg |
| Nihon Aerogil Co., Ltd.) | | |
| Water | 33 | L |
| Boric acid | 0.27 | kg |
| Borax | 0.24 | kg |
| Ethanol | 2.2 | L |
| Cationic polymer P-1, 25% aqueous solution | 14 | L |
| Cationic polymer (PAS-H-5L, 28%, Nittobou Co., Ltd) | 4 | L |
| Anti-color fading agent AF1*¹, 10% aqueous solution | 8.5 | L |
| Fluorescent whitening agent*² | 0.1 | L |

*¹Anti-color fading agent AF-1 HO—N(C₂H₄SO₃Na)₂
*²Uvitex NFW Liquid, Ciba Specialty Chemicals Co., Ltd.

The above components were dispersed by a high pressure homogenizer manufactured by Sanwa Co., Ltd., to prepare Silica Dispersion D2.

Thus obtained Recording mediums 38 through 44 were evaluated in the same manner as in Example 1.

Results of the evaluation are listed in Table 3.

TABLE 3

| | | | Time | | | | | Printed | |
|---|---|---|---|---|---|---|---|---|---|
| | Heating | Heating | after | | | | | image | |
| | temperature | time | heating | *1 | *2 | *3 | *4 | density | Remarks |
| Recording | 48° C. | 2 hours | 20 | A | E | E | C | 1.73 | Comp. |
| medium 38 | | | minutes | | | | | | |
| Recording | 48° C. | 2 hours | 40 | A | B | C | A | 2.13 | Inv. |
| medium 39 | | | minutes | | | | | | |
| Recording | 48° C. | 2 hours | 1 hour | A | A | C | A | 2.14 | Inv. |
| medium 40 | | | | | | | | | |
| Recording | 48° C. | 2 hours | 2 hours | A | A | B | A | 2.18 | Inv. |
| medium 41 | | | | | | | | | |
| Recording | 48° C. | 2 hours | 3 hours | A | A | C | A | 2.16 | Inv. |
| medium 42 | | | | | | | | | |
| Recording | 48° C. | 2 hours | 5 hours | A | B | C | A | 2.15 | Inv. |
| medium 43 | | | | | | | | | |
| Recording | 48° C. | 2 hours | 6 hours | A | E | D | C | 1.77 | Comp. |
| medium 44 | | | | | | | | | |

*1: State of dispersion,
*2: State of mixing,
*3: Viscosity increasing during standing,
*4: Coating defect
Comp.: Comparative,
Inv.: Inventive.

Tables 1 through 3 display that the producing method using the dispersion stood for 0.5 to 5 hours after the heating is superior in the stability of the coating liquid and in the coating suitability and the recording medium prepared by the method has high quality. The stability of the coating liquid is further improved by the use of the water-soluble polyvalent metal or two or more kinds of the cationic polymers, and such the embodiments are preferable.

1. A recording medium producing method comprising a step of coating a coating liquid which is a mixture of an inorganic fine particle dispersion and a water-soluble binder on a support, wherein the inorganic fine particle dispersion is prepared by a process comprising the steps of heating an inorganic fine particle dispersion at a temperature of from 45° C. to 60° C. for a time of from 0.5 to 5 hours, standing the inorganic fine particle dispersion at a temperature of from 10° C. to 40° C. for a time of from 0.5 to 5 hours, and mixing the inorganic fine particle dispersion with the water-soluble binder.

2. The recording medium producing method of claim 1, wherein the inorganic fine particle is fumed silica and the inorganic fine particle dispersion contains a cationic polymer.

3. The recording medium producing method of claim 1, wherein the inorganic fine particle dispersion contains a water-soluble poly-valent metal compound.

4. The recording medium producing method of claim 2, wherein the inorganic fine particle dispersion contains two or more kinds of cationic polymer.

5. A recording medium produced by the producing method of claim 1.
